(19) United States
(12) Patent Application Publication
(10) Pub. No.: US 2018/0240185 A1
(43) Pub. Date: Aug. 23, 2018

(54) SYSTEM AND METHOD FOR GROUP PURCHASING AND SHARING

(71) Applicant: VIY, INC., Indianapolis, IN (US)

(72) Inventors: Jacob Leffler, Indianapolis, IN (US); Brian Phillips, Indianapolis, IN (US)

(21) Appl. No.: 15/752,149

(22) PCT Filed: Aug. 12, 2016
(86) PCT No.: PCT/US16/46730

§ 371 Date: Feb. 12, 2018

Related U.S. Application Data
(60) Provisional application No. 62/204,109, filed on Aug. 12, 2015.
(60) Provisional application No. 62/258,857, filed on Nov. 23, 2015.

(51) Int. Cl. G06Q 30/06; G06Q 50/00; G06F 17/30

(52) U.S. Cl. CPC G06Q 30/0645; G06F 17/30861; G06Q 30/0623; G06Q 50/01

(57) ABSTRACT

A system and method for group purchasing and sharing is disclosed. The system and method includes receiving, at a web services infrastructure, an item information pertaining to an item from a user device, the item information comprising at least one of a name and photograph, automatically adding a user associated with the user device to the item information, associating the user as owner of the item to the item information, receiving, at the web services infrastructure, an indication from the user device to share the item with a plurality of trusted users, automatically assigning a status of the item as available, and sharing, through the web services infrastructure, to the plurality of trusted users, the item.

### PRIORITY

The present application claims benefit from U.S. provisional patent applications, Ser. No. 62/204,109, filed Aug. 12, 2015, and Ser. No. 62/258,857, filed Nov. 11, 2015, both of which are incorporated in their entireties by reference herein.

### BACKGROUND

We live in a consumer driven world where the economy is largely controlled by and focused on consumers purchasing items (and/or services) to fulfill their needs. Some of these items (and/or services) are frequently used, and worth the purchase cost; other times are used infrequently, but nonetheless require purchase because access to these items would otherwise be unavailable. This purchase-driven economy has been traditionally viewed as the norm.

Consumers of the current generation (e.g. millennials) are the first in the modern era to have higher levels of student loan debt, poverty and unemployment, and lower levels of wealth and personal income than the two immediate past generations had at the same age. These types of consumers with limited funds cannot always afford to buy a new item in response to a new desire. This is most prevalent in purchases of large durable goods, which are of a high cost, used infrequently, and take up large amounts storage space.

In a sharing-driven economy as opposed to a purchase-driven economy, consumers could share items between each other to remove the burdens discussed above. That is, rather than purchase a large durable good outright, use it once, and then see it taking up large amounts of storage space in a home, a consumer could borrow that item from someone who had previously purchased it. We see this model work in a very limited capacity with some hardware stores offering rental services (e.g. rent a power washer from Home Depot for $50 rather than spend $250 to buy one and store it). However, a model of rental from business to consumer is costly.

Consumers would prefer a lower cost option that enables consumer to consumer sharing. One key issue with consumer to consumer sharing at a large scale is that consumers may not want to borrow a durable good from someone they do not know and, similarly, consumers may not want to share their purchased durable goods to someone they do not know. A consumer might be concerned with the item breaking, being stolen, or misused by people they do not know. This concern is lessened when sharing occurs through a network of trusted friends, family and co-workers and/or when consumers can look at past sharing history and reviews of these other consumers.

For example, a fondue set is not an item that is traditionally used with much frequency in most households. If a special occasion arises when a consumer needs a fondue set and does not have one, traditionally that consumer would go out and buy it. This fondue set, then, would gather dust in the consumer's home for the one or two times a year in which it might be used. In a sharing driven economy, however, rather than buy the fondue set outright, the consumer can find another consumer they trust (e.g. friend, consumer with good reviews and high frequency of sharing, etc.) to borrow the fondue set from for those one or two special occasions each year.

The sharing-driven model realizes savings in dollars and storage space, while also reducing waste. Rather than multiple consumers purchasing multiple fondue set, one consumer purchases a fondue set and loans it out to those that need it.

A sharing-driven economy has an additional issue that can be solved: who bears the burden of the initial purchase of that durable good? Ideally, consumers in a sharing-driven economy may want to pool together spending power to purchase a durable good that individually they may not be able to afford or may not desire to purchase outright. Take the fondue set example: If a group of ten consumers each want to use a fondue set once per year, no single consumer would benefit from owning it outright. However, if each of these ten consumers shares 1/10 of the cost of the fondue set (and one consumer is willing to store it), the pool of consumers might benefit from owning the fondue set as a group.

Traditional sharing of items and group purchasing of items require coordination amongst groups of consumers. For example, a collective of consumers must come together, decide on an item to purchase, share in the purchase price, purchase the item, coordinate storage of the item, and coordinate sharing of the item. Furthermore, the social mores against sharing and asking to borrow someone else's items creates additional hesitation on the part of consumers who are interested in item sharing. As a result, consumers continue to engage the purchase driven model of acquiring items, whereby items are individually purchased.

Accordingly, there exists a need for a system and method for group purchasing and sharing of items and services. Moreover, there exists a need for a system and method that can efficiently, reliably, and quickly allows consumers to purchase, and share items and services, thereby decreasing spending and associated storage costs.

### BRIEF DESCRIPTION OF THE DRAWINGS

FIG. 1 shows a schematic drawing of an architecture of a system for group purchasing and sharing, according to at least one embodiment of the present disclosure.

FIG. 2 shows a combination flowchart of a method and components of a system and method for group purchasing and sharing, according to at least one embodiment of the present disclosure.

FIG. 2a shows a combination flowchart of a method and components of a system and method for group purchasing and sharing, according to at least one embodiment of the present disclosure.

FIG. 3 shows a combination flowchart of a method and components of a system and method for group purchasing and sharing, according to at least one embodiment of the present disclosure.

FIG. 3a shows a schematic drawing of an architecture of a system for group purchasing and sharing, according to at least one embodiment of the present disclosure.

FIG. 4 shows a combination flowchart of a method and components of a system and method for group purchasing and sharing, according to at least one embodiment of the present disclosure.

FIG. 5 shows a schematic drawing of an architecture of a system for group purchasing and sharing, according to at least one embodiment of the present disclosure.

FIG. 6 shows a schematic drawing of an architecture of a system for group purchasing and sharing, according to at least one embodiment of the present disclosure.

FIG. 7 shows a schematic drawing of an architecture of a system for group purchasing and sharing, according to at least one embodiment of the present disclosure.

FIG. 8 shows a schematic drawing of an architecture of a system for group purchasing and sharing, according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in any programming language—interpreted, compiled, or otherwise. These languages may include, but are not limited to, Xcode, iOS, cocoa, cocoa touch, MacRuby, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Node.js, Zend, Symfony, Revel, Django, Struts, Spring, Play, Jo, Twitter Bootstrap and others. It should further be appreciated that the systems and methods disclosed herein may be embodied in software-as-a-service available over a computer network, such as, for example, the Internet. Further, the present disclosure may enable web services, application programming interfaces and/or service-oriented architecture through one or more application programming interfaces or otherwise.

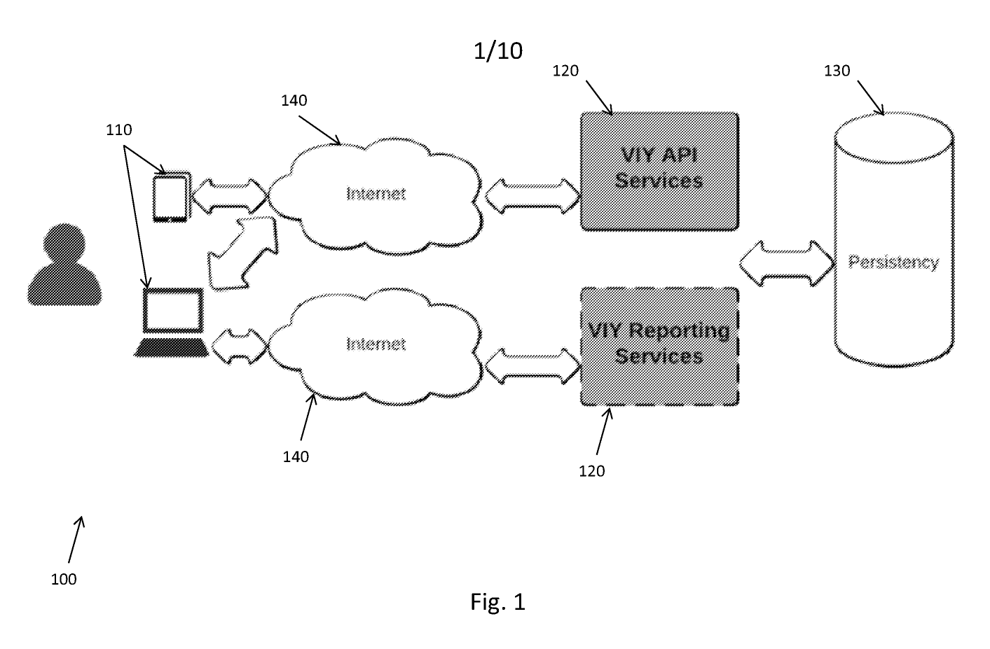

Referring now to FIG. 1, there is shown a schematic drawing of a system 100 for providing group purchasing and sharing. In at least one embodiment of present disclosure, the system 100 comprises user devices 110, web services infrastructure 120, database 130, and computer network 140.

The user device 110 may be configured to transmit information to and generally interact with a web services and/or application programming interfaces infrastructure 120 housed on one or more servers over computer network 140. The user device 110 may include a web browser, mobile application, socket or tunnel, or other network connected software such that communication with the web services infrastructure 120 is possible over the computer network 140.

The user device 110 includes one or more computers, smartphones, tablets, wearable technology, computing devices, or systems of a type well known in the art, such as a mainframe computer, workstation, personal computer, laptop computer, hand-held computer, cellular telephone, MP3 player, or personal digital assistant. The user device 110 comprises such software, hardware, and componentry as would occur to one of skill in the art, such as, for example, one or more microprocessors, memory systems, input/output devices, device controllers, and the like. The user device 110 also comprises one or more data entry means (not shown in FIG. 1) operable by users of the user device 110 for data entry, such as, for example, voice or audio control, a pointing device (such as a mouse), keyboard, touchscreen, microphone, voice recognition, and/or other data entry means known in the art. The user device 110 also comprises a display means (not shown in FIG. 1) which may comprise various types of known displays such as liquid crystal diode displays, light emitting diode display, and the like upon which information may be display in a manner perceptible to the user. It will be appreciated that user device 110 may further comprise a Global Positioning System (GPS) transceiver and such software, hardware, and componentry as would occur to one of skill in the art, to operably perform the functions allocated to the user device 110 in accordance with the present disclosure.

The database 130 is configured to store information generated by the system 100 and/or retrieved from one or more information sources. Database 130 can be associated with the web service infrastructure 120 where database 130 resides on a server or computing device remote from any server for web services infrastructure 120, provided that the remote server or computing device is capable of bi-directional data transfer with such server, such as, for example, in Amazon AWS, Rackspace, or other virtual infrastructure, or any business network.

For purposes of clarity, database 130 is shown in FIG. 1, and referred to herein as a single database. It will be appreciated by those of ordinary skill in the art that database 130 may comprise a plurality of databases connected by software systems of a type well known in the art, which collectively are operable to perform the functions delegated to database 130 according to the present disclosure. Database 130 may also be part of distributed data architecture, such as, for example, a Hadoop architecture, for big data services. Database 130 may comprise relational database architecture, noSQL, OLAP, or other database architecture of a type known in the database art. Database 130 may comprise one of many well-known database management systems, such as, for example, MICROSOFT's SQL Server, MICROSOFT's ACCESS, MongoDB, Redis. Hadoop, or IBM's DB2 database management systems, or the database management systems available from ORACLE or SYBASE. Database 130 retrievably stores information that is communicated to database 130 from user device 110 or server 120.

It should be appreciated that FIG. 1 displays one embodiment of an architecture 100 compatible to execute the methods described herein. The architecture 100 minimally requires a user device 110 accessing a web services infrastructure 120 over a computer network 140 which, in turn, stores user information and other application information in a database 130. This minimal system shall be referred to herein as the “Viy system.”

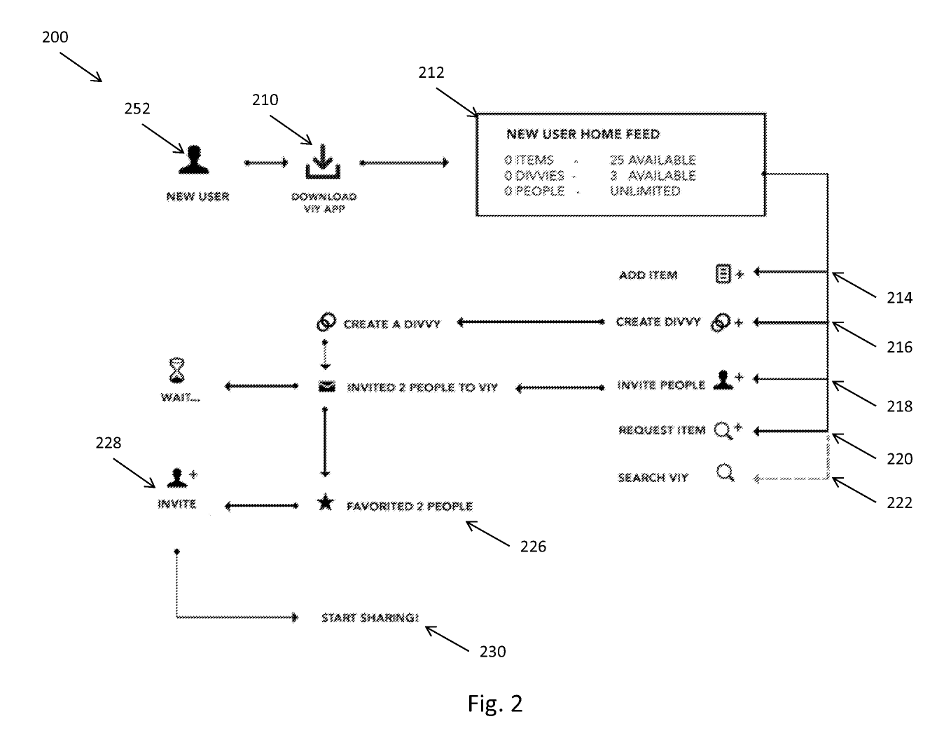

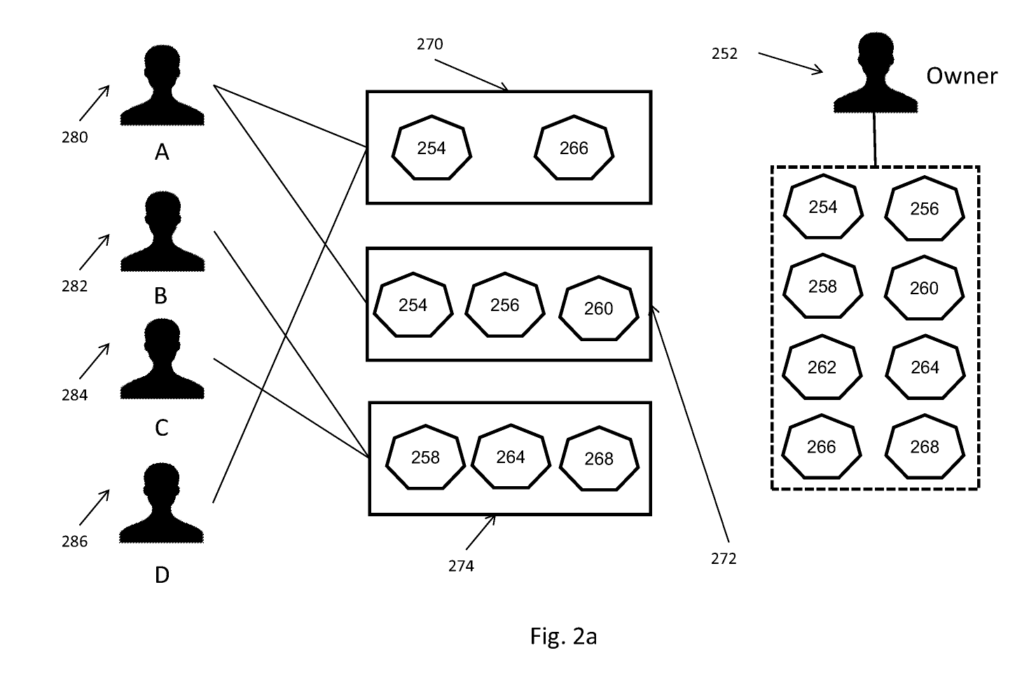

Referring now to FIG. 2, it is shown a flowchart of a method and components for group purchasing and sharing, generally indicated at 200. In at least one embodiment of the present disclosure, the method 200 comprises step 210 of downloading software, step 212 of setting up a user home, step 214 of adding an item, step 216 of creating a divvy, step 218 of inviting people, step 220 of requesting an item, step 222 of searching, step 226 of inviting people to a divvy, step 228 of selecting favorites, and step 230 of sharing.

In at least one embodiment of the present disclosure, the method 200 includes downloading software in step 210. In a preferred embodiment, a user 252 accesses the Viy system through a software application on a smartphone or tablet. The user 252 may download the software through a user device 110 and over computer network 140, such as, for example, through a smartphone application store (e.g. iTunes, Google Play). Of course, it should be appreciated that step 210 is not limited to software on a smartphone and that user 252 may access the Viy system through a traditional web browser or other network-capable communication software.

In step 212, the user 252 is provided with an initial configuration (e.g. registration) of a user account to the Viy system. The user 252 may be required to specify login credentials, such as, for example, a user name and password combination during a registration process. The user 252 may also be prompted to provide other demographic information, such as an email address, name, phone number, zip code, to name a few non-limiting examples. The initial configuration may include a tutorial for the user 252 on how to operate and engage the Viy system.

In step 214, user 252 can add an item that the user 252 is willing to share through the Viy system with other users. In at least one embodiment of the present disclosure, the user 252 can use user device 110 to take a photograph of the item to be added. The user 252 can further provide a title and a description of the item to be shared. In at least one embodiment of the present disclosure, the user 252 may be allowed to select an item from a pre-configured list of items from database 130. The user 252 may also be allowed to select a plurality of categories to classify the items. For example, a lawn mower item may be categorized under the outdoor tools category, and a kitchen mixer may be categorized under the cooking equipment category. It will be further appreciated that user 252 can select pre-defined categories, or create new categories for their items. In at least one embodiment of the present disclosure, an item may have pre-defined defaults to categorize an item.

In step 214, the Viy system inserts the specifications of the item added by the user in database 130. It should be appreciated that the Viy system may insert all of the information provided by the user (title, photograph, etc.) and associates it with the item. The Viy system may also associate additional information about the added item, such as, for example, that the user is the owner of the item. The Viy system may also assign a retail value for the added item in the database 130 based on other items added by similar users or by obtaining market information about the item.

It should be appreciated that step 214 may be performed multiple times to add multiple items to the Viy system. Of course, additional users of the Viy system may also add items by executing step 214 one or more times, thereby creating a list of items available for sharing through the Viy system within database 130.

In step 216, a user creates a divvy in the Viy system. As used in the present disclosure, a “divvy” is a group of items available for sharing to a group of consumers. In the Viy system, a user 252 may create any number of divvies with any number of items that the user has added to the Viy system previously in step 214. For example, referring to FIG. 2a, it is shown an organization of items in divvies, according to at least one embodiment of the present disclosure. In FIG. 2a, user 252 may share any of the items added by user 252 (e.g. items 254-268) with any number of other users acting as borrowers (e.g. borrower 280-286) through one or more divvies.

Divvy 270 displays one such example. As shown in divvy 270, user 252 has added item 254 and 266 to be shared to users in this divvy. As further shown in FIG. 2a, users 280, 282, 284, 286 may be given access to a divvy. For example, users 280 and 286 are given access to divvy 270, which contains items 254 and 266. In another example, as shown in FIG. 2a, users 282 and 284 are given access to divvy 274, which has items 258, 264, and 268 available to share. It should be appreciated that user 252 may freely add or remove items from divvies he or she owns.

In at least one embodiment of the present disclosure, each item in a divvy is assigned a status. The status of each item includes, such as, for example, the item is available to be borrowed, the item is on loan to a borrower, the item is lost, or that the item is unavailable (for any other reasons). It will be appreciated that the status of each item can be used to determine wither an item is available to be shared within a divvy (as disclosed further below). Of course, each divvy, items assigned to each divvy, and a status of each item is stored in database 130.

A divvy, then, represents a group of people each sharing a group of items. For example, if item 254 is a lawnmower and item 266 is a fondue set, each of which user 252 owns, user 252 offers user 280 and user 286 to borrow these items through divvy 270.

Referring back to FIG. 2, in step 218 people are invited to join the Viy system. User 252 may desire to share items across his/her network of friends, family and co-workers. In at least one embodiment of the present disclosure, user 252 can invite contacts in an address book on user device 110, or by any means appreciated by those of ordinary skills in the art. In at least one embodiment of the present disclosure, user 252 can initiate communications with proposed invitees via text message, or other communication methods appreciated by those of ordinary skills in the art. In at least one embodiment of the present disclosure, user 252 may engage invitees from other third party application platforms such as, for example, Facebook®, Twitter®, and LinkedIn®. It will be appreciated that such third party application platforms may be accessed via their respective third party applications programming interfaces, via network 140, and is operably configured as would occur to one of ordinary skill in the art. Upon receiving an invitation into a divvy, the recipient can accept the invitation, thereby becoming a member of the divvy. In at least one embodiment, the user may, using system 100, configure one or more of the user's divvies so that some predefined group or anyone can join the group to borrow and share items without the user having to issue invitations. In other words: anyone can join without being specifically invited; anyone within some pre-defined group (e.g. church group, Facebook friends) can join without being specifically invited; a user preselected group of individuals or organizations can join without being specifically invited.

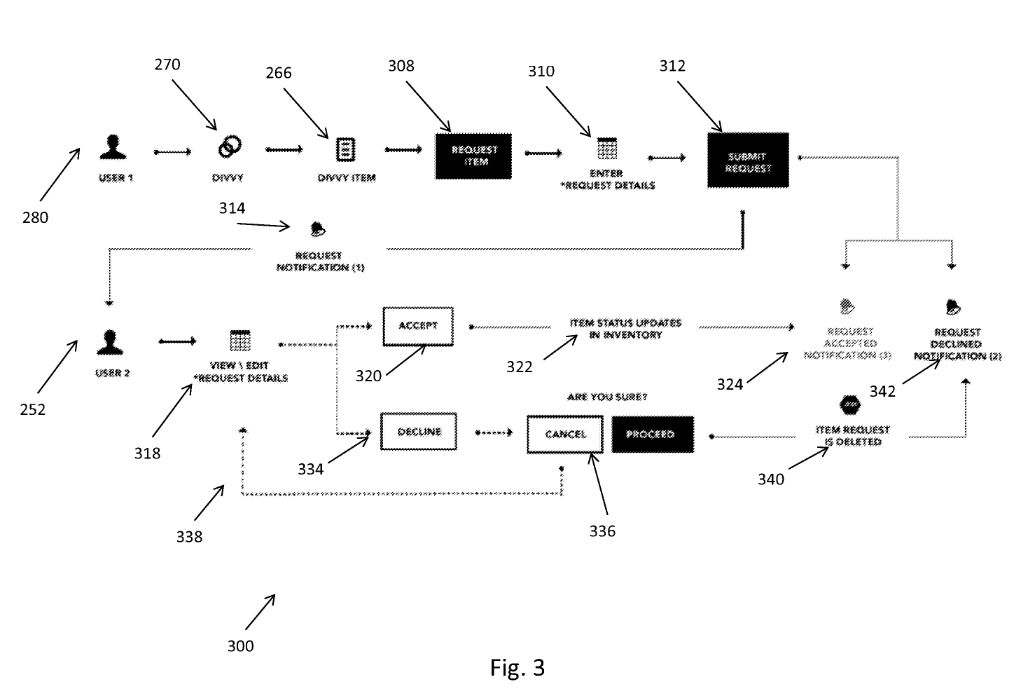

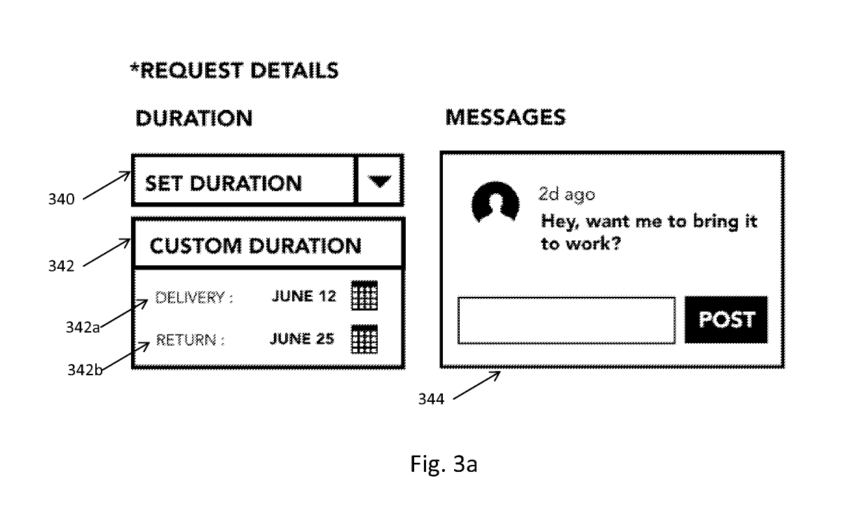

In step 220, user 252 can request an item as further disclosed at step 308 of FIG. 3. In at least one embodiment, the system 100 can be configured to allow a search among divvies in which the searching user does not have membership or has not otherwise been invited. In such an embodiment, this user may be allowed to search and view items (which may be a subset of all items for each owner, the owner specifying which of his or her items may be viewable and/or borrowable by such users) and send a request to either borrow the item or request to join the applicable divvy, and if approved, then the user can request to borrow the item as a divvy member (or guest user if a more limited status is preferred) as described elsewhere herein. In at least one embodiment, the owner (or other delegate) of the divvy may use system 100 to configure the divvy or select items to be open for such searching generally, or by some preselected group of persons (such as members of a church or club who are identified in the system 100 as such).

In step 222, user 252 can search the system 100 for items to borrow. In at least one embodiment of the present disclosure, user 252 can request a new item from a divvy in which they are a member. It will be appreciated that system 100 allows for user 252 to input a search query to provide details of the item he/she is searching for. In at least one embodiment of the present disclosure, user 252 can select at least on divvy or a plurality of divvies to send the request. If the search yields a successful hit (i.e. that the item 266 is available), then the user 252 can send a request as further disclosed here in at step 308 of FIG. 3.

In at least one embodiment of the present disclosure, the user 252 can view all items in system 100, view items by category, view items that are available for exchange (i.e. available for borrowing), and items that are unavailable for exchange. It will be appreciated that the user 252 can have the option of sorting.

In step 226, user 252 can “favorite” other users (e.g. borrower 280-286). It will be appreciated that by designating another user as a “favorite,” the user 252 can share messages and favorited users are afforded additional features of the disclosure as disclosed further herein.

In step 228, user 252 can invite other users (e.g. borrower 280-286) into a divvy (e.g. divvy 270). In at least one embodiment of the present disclosure, where user 252 invites a user into a divvy, the user 252 can share specific items with the users that have been invited into and accept admission into the divvy. For example, referring to FIG. 2a, user 252 has created a plurality of divvies-divvy 270, divvy 272, and divvy 274. In divvy 270, user 252 has added item 254 and item 266; in divvy 272, user 252 has added item 254, item 256, and item 260; in divvy 274, user 252 has added item 258, item 264, and item 268. It will be appreciated that each divvy serves to segregate the items belonging to user 252, into parts that will be shared with specific individual(s). For example, user 252 has invited borrower 280, and borrower 286 to join divvy 270; user 252 has invited only borrower 280 to join divvy 272; and user 252 has invited borrower 282 and borrower 284 to join divvy 274. Upon acceptance of the divvy invitation, the each borrower becomes a member of the divvy and can borrow the each item(s) within the divvy. Borrower 280 and borrower 286 can view items in divvy 270; borrower 280 can also view items in divvy 272; and borrower 282 and borrower 284 can view items in divvy 274. It will be appreciated that user 252 might invite any number of borrowers to a divvy, from one borrower to any number of borrowers.

In at least one embodiment of the present disclosure, user 252 can also delegate ownership of the divvy 270 (or create co-ownership or authorizations with respect to management of one or more aspects of the divvy) to other users (e.g. borrower 280-286). This delegation allows the delegate to manage the divvy 270 and organize the items therein. For example, user 252 can delegate ownership of divvy 270 to previously invited borrower 280 or borrower 286. Borrower 280 (or borrower 286) can then manage divvy 270 in the place of user 252, or even replace user 252 for example if user 252 no longer wishes to participate in or manage the divvy.

In step 230, the user 252 can start sharing items with other users (e.g. borrowers 280-286), as will be disclosed further herein.

Referring now to FIG. 3, it is shown a flowchart of a method and components for group purchasing and sharing, generally indicated at 300. In at least one embodiment of the present disclosure, borrower 280 desires to borrow item 266. Item 266 can be found in divvy 270. Borrower 280 may access system 100 (e.g. via a user device 110), to view divvy 270. It will be appreciated that borrower 280 must have previously been invited into divvy 270 (as disclosed in step 228 of FIG. 2). Borrower 280 operates user device 110 to request an item 266 from divvy 270.

In step 310, borrower 280 can enter request details. In at least one embodiment of the present disclosure, request details include information such as, for example, how long borrower 280 wants to borrow item 266, when borrower 280 wants to borrow item 266, when borrower 280 will return item 266, the location where borrower 280 will pick up or receive, as well as return item 266, and other details pertinent to a request as will be known to one having ordinary skill in the arts. For example, referring to FIG. 3a, it is shown an embodiment of entering request details, according to at least one embodiment of the present disclosure. Borrower 280 can set duration 340 for the request. In at least one embodiment of the present disclosure, duration 340 can be any measure of time or duration, such as, for example, a number of days, months, years, or the occurrence of an event. It will be appreciated that duration 340 can be pre-set by system 100 to include pre-defined durations. In at least one embodiment of the present disclosure, borrower 280 can create a custom duration 342. Custom duration 342 includes a delivery date 342a, wherein borrower 280 can request to obtain possession of the requested item 266. Custom duration 342 also includes a return date 342b, wherein borrower 280 can indicate when the item 266 will be returned. In at least one embodiment of the present disclosure, borrower 280 can also compose message 344 as part of the request details. It will be appreciated that message 344 can be composed using user device 110, via any means known to one having ordinary skill in the arts. In at least one embodiment of the present disclosure, message 344 can be composed to include any additional details that borrower 280 may want to either inquire about, or convey regarding the request details.

In step 312 of FIG. 3, borrower 280 submits the request for item 266. In at least one embodiment of the present disclosure, the system 100 receives the request details that were created in step 308. This may include the borrower 280's first name and first initial of last name, a message, the identification of the item, and the request details. Upon system 100 receiving the request, a request notification is created in step 314. In at least one embodiment of the present disclosure, user 252 receives a request notification. The request notification may be a notification alert on user 252's user device 110, a message on user 252's user device 110, or any other means known to one having ordinary skill in the art.

In step 318, user 252 can view the request details. In at least one embodiment of the present disclosure, user 252 receives the request because user 252 is the owner of divvy 270 (which includes item 266). It will be appreciated that a delegatee of user 252, who has been delegated administrative privileges over divvy 270 may also receive the request notification from step 314, and will have the ability to view the request details in step 318.

In step 320, the user 252 can ‘accept’ the request for item 266. In at least one embodiment of the present disclosure, the user 252 is presented with a GUI via user device 110. The user 252 can operate user device 110 to ‘accept’ the request, which indicates that the user 252 is looking to accept the terms of the request and to let the borrower 280 obtain item 266. In step 322, the status of item 266 is updated to indicate that item 266 is scheduled to be borrowed. It will be appreciated that the change in status of item 266 will, in one embodiment, render the item 266 unavailable for borrowing by any other borrower of the divvy 270. In another embodiment, the item 266 may be requested but scheduled for borrowing at some later time (so that, for example, an item 266 such as a lawn aerator can be ‘reserved’ during the autumn weeks by several users who are neighbor). In other embodiments, when an item 266 is either scheduled or otherwise has been borrowed but not yet returned, the item 266 may be completely removed (i.e. does not appear in inventory or search results), or the functionality of the system 100 may be reduced or otherwise altered to eliminate the ability to request the item 266 be borrowed, or alternatively allow it to be requested, but not schedule, or allow it to be scheduled tentatively but not allow scheduling or arranging pick up or drop off details until the item is actually returned by the current borrower, and other variations. It will be further appreciated that if item 266 was originally placed in a plurality of divvies, then a change in the status of item 266 will result in a corresponding change in status of item 266 in the other divvies as well.

In step 324, borrower 280 receives a notification that his/her item request was accepted. In at least one embodiment of the present disclosure, the notification may be a notification alert on borrower 280's user device 110, a message on borrower 280's user device 110, or any other means known to one having ordinary skill in the art.

Alternatively, at step 334, if user 252 desires to ‘decline’ the request for item 266, user 252 can operate user device 110 to ‘decline’ the request. In at least one embodiment of the present disclosure, user 252 may further be prompted for confirmation at step 336 to ensure that user 252 does want to decline the item request. It will be further appreciated that when user 252 confirms his/her desire to reject the request, the item request is deleted in step 340. In at least one embodiment of the present disclosure, the item 266 will remain available in divvy 270 (as well as any other divvies it was placed in).

In step 342, borrower 280 receives a notification that his/her item request was declined. In at least one embodiment of the present disclosure, the notification may be a notification alert on borrower 280's user device 110, a message on borrower 280's user device 110, or any other means known to one having ordinary skill in the art.

It will be further appreciated that user 252 will be presented the request details at step 318 again, if user 252 does not confirm the ‘decline’ of the request in step 336.

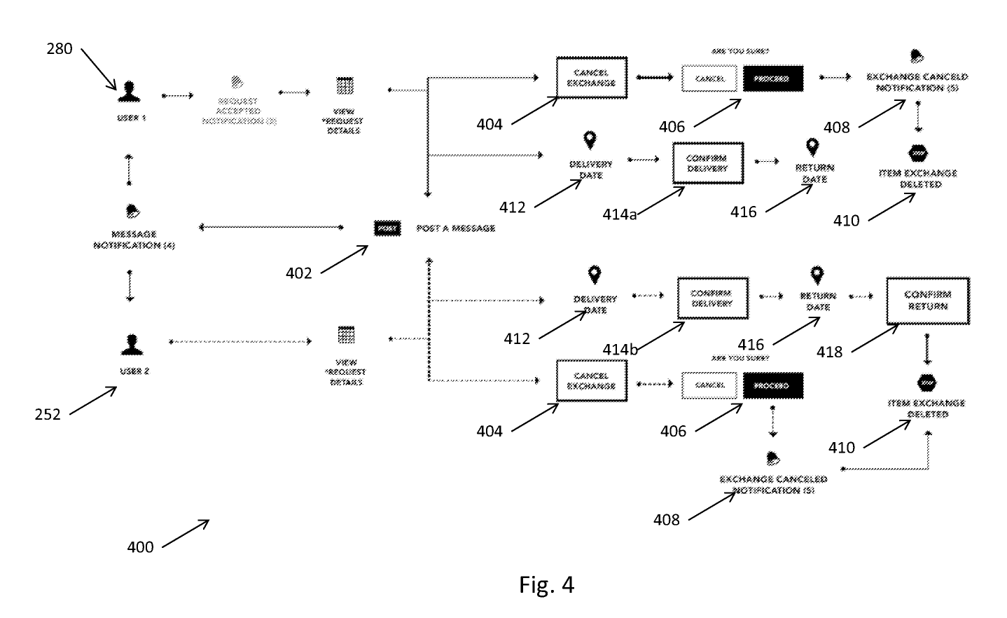

Referring now to FIG. 4, it is shown a flowchart of a method and components for group purchasing and sharing, generally indicated at 400. In at least one embodiment of the present disclosure, flowchart 400 illustrates the steps for an exchange of an item 266 between user 252, and borrower 280. It will be appreciated that borrower 280 has already initiated a request for item 266, as disclosed previously. It will be further appreciated that user 252 has accepted borrower 280's request.

In at least one embodiment of the present disclosure, borrower 280 and user 252 will coordinate the logistics of the exchange of item 266. For example, borrower 280, or user 252 can post messages at step 402 to exchange information such as, for example, an address of a meeting location, or any specific instructions pertinent to the exchange.

In step 404, either borrower 280 or user 252 can cancel the exchange. In at least one embodiment of the present disclosure, either party can operate their respective use device 110 to indicate that the exchange is to be cancelled. If either party initiates a cancellation, they are prompted for a cancellation confirmation at step 406. If the cancellation is confirmed by the “cancelling” party, the “non-cancelling” party is given a notification at step 408. In at least one embodiment of the present disclosure, the notification may be a notification alert on the non-cancelling party's user device 110, a message on non-cancelling party's user device 110, or any other means known to one having ordinary skill in the art.

In step 410, upon cancellation of the planned exchange, the exchange of item 266 is deleted by system 100, and item 266's status does not change as disclosed in step 334 of FIG. 3.

In at least one embodiment of the present disclosure, if neither borrower 280 nor user 252 cancel the exchange, both parties prepare for the exchange on the delivery date, at step 412. It will be appreciated that the system 100 may remind either party of the exchange or of any special instructions, or other information relevant to the exchange, in preparation for the exchange of the item 266. On the delivery date, the exchange can be consummated by any means known to one having ordinary skills in the art. For example, as simple face-to-face handoff of the item 266 can complete the exchange; if item 266 is for services, the performance of the services can also complete the exchange. It can be further appreciated that item 266 could be mailed or otherwise delivered, and that such delivery services could be integrated with system 100 to facilitate scheduling delivery to the borrower's home or other established delivery location.

In at least one embodiment of the present disclosure, borrower 280 can confirm delivery at step 414a, or user 252 can confirm delivery at 414b. It will be appreciated that either party may operate their respective user device 110 to indicate confirmation of the delivery. It will be appreciated that either party can mark the completion of the exchange at step 414a/b. In at least one embodiment of the present disclosure, both parties will have to indicate the completion of the exchange (i.e. borrower 280 will have to confirm delivery at step 414a; and user 252 will have to confirm delivery at step 414b).

In step 416, borrower 280 must return item 266 to user 252 on the previously agreed to return date. In at least one embodiment of the present disclosure, either party can exchange information or other details pertinent to the exchange, prior to the return date. Upon return of item 266 to user 252, by borrower 280, user 252 may confirm the return in step 418. It will be appreciated that user 252 may delegate the step of confirming the return to another member of the divvy 270 (from which item 266 belongs to).

In at least one embodiment of the present disclosure, after the return is confirmed at step 418, the system 100 may update the status of item 266 to indicate that it is again available for borrowing, and in some embodiments re-enable any system 100 functionality that was reduced or disabled to again allow searching, viewing, scheduling, and/or arranging pick up/delivery. It will be appreciated that if the item 266 was originally listed in a plurality of divvies, the status of item 266 in the each of the plurality of divvies will be updated respectively.

In at least one embodiment of the present disclosure, the system 100 may remind user 252 (and borrower 280) of any upcoming exchanges. For example, if a delivery has not already been confirmed at 7 PM local time on the day prior to the scheduled delivery, the system 100 sends a delivery reminder push notification to the user 252. If the delivery of item 266 has not been confirmed at 7 AM local time on the day after the scheduled delivery, the system sends a confirm delivery reminder push notification to the user 252 and borrower 280. If the return of item 266 has not already been confirmed at 7 PM local time on the day prior to the scheduled return, the system 100 sends a return reminder push notification to the borrower 280. If the return of item 266 has not been confirmed at 7 AM local time on the day after the scheduled return, the system sends a confirm return reminder push notification to the user 252.

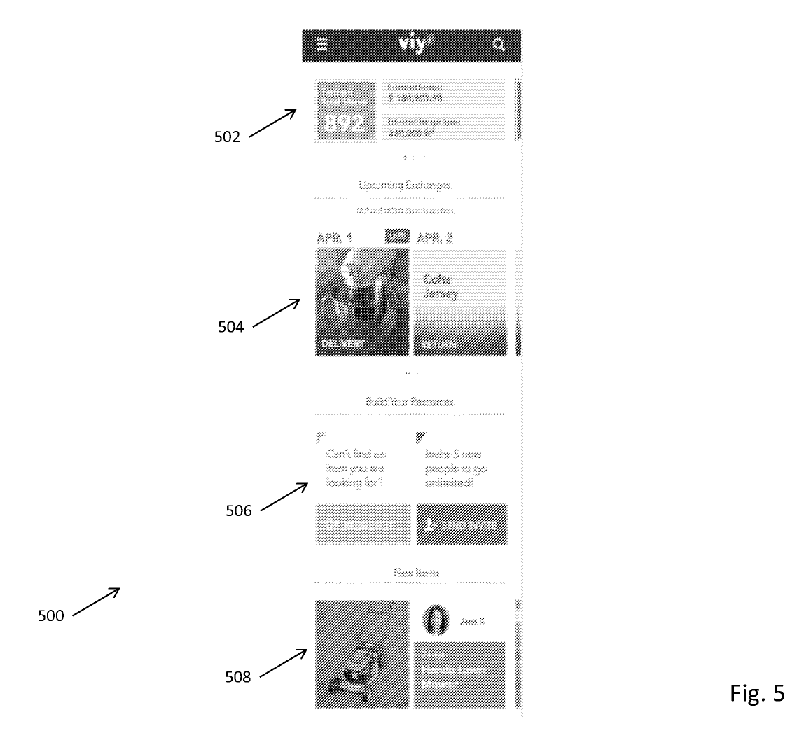

Referring now to FIG. 5, it is shown a schematic drawing for a group purchasing and sharing, generally indicated at 500. In at least one embodiment of the present disclosure, the schematic 500 illustrates a dashboard presented to a user 252, via the user 252's user device 110. The schematic 500 includes a home feed 502, upcoming exchanges 504, resources panel 506, and new items panel 508.

Home feed 502 saving statistics using predefined cost and space saved by item category for each shared item. For example, if the cost of item 266 is approximately $30, by being able to borrow item 266, borrower 280 will be able to save the $30 purchase cost of the item 266. It will be appreciated that the cost (or other saving statistics) of item 266 can be manually entered or pulled from one or more third party databases and third party applications that contain pricing information, as will be known to one having ordinary skill in the art. It will be further appreciated that home feed 502 can further display other statistics such as, for example, the amount of space saved by not having to permanently house a purchase, or the amount of natural resources saved by not requiring purchase of another item.

In at least one embodiment of the present disclosure, the saving statistics displayed in home feed 502 includes the total number of items shared, the money saved, and storage space saved across all of user 252's divvies, or in a specific divvy. It will be appreciated that the saving statistics includes the total number of items share, money saved, and storage space saved by the user 252 amongst his/her own items that were shared across all divvies or in a specific Divvy. It will be further appreciated that the saving statistics displayed in home feed 502 includes the total number of shares, money saved, and storage space saved by all users of the system 100. In other embodiments, additional saving statistics may be accessed and calculated including energy savings, materials savings, landfill savings, time savings, and the like.

Upcoming exchanges 504 is used to display any exchanges that the user 252 has upcoming.

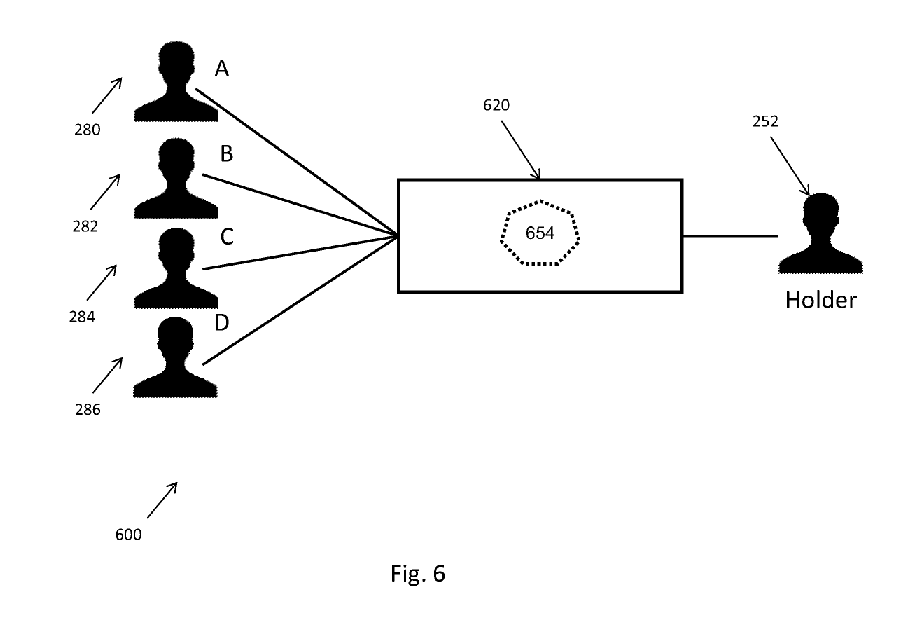

Referring now to FIG. 6, it is shown a schematic drawing for group purchasing and sharing, generally indicated at 600. In at least one embodiment of the present disclosure, a group of individuals can collaborate to purchase an item for sharing. For example, borrower 280 may desire to borrow an item 654 that is not currently in the divvy (and has never been available because no member of the divvy has item 654). In at least one embodiment of the present disclosure, the members (i.e. borrowers 280-286, and user 252) of the divvy can collaborate to perform a group purchase of the item 654.

In at least one embodiment of the present disclosure, once an item has been selected members of the divvy, the members can coordinate with each other regarding matters such as, for example, where the purchase is to be made, who will make the purchase, how much money is to be spent, how will the cost of the item be split amongst the members, and how funds are to be transferred to facilitate the purchase. In at least one embodiment of the present disclosure, a single member (e.g. user 252) can decide such matters, and the other members (e.g. borrowers 280-286) of the divvy can participate in the purchase or can abstain from the purchase.

It will be appreciated that one member (i.e. the purchaser member) can be designated to make the purchase on behalf of the group. A member who is designated to make the purchase on behalf of the divvy can make all or many of the decisions regarding the purchase of item 654. The other members (i.e. the contributing members) can decide whether or not to participate.

In at least one embodiment of the present disclosure, money can be transferred from accounts of the contributing members to an account of the purchaser members and the purchaser members can make the purchase. For example, all of the members of the divvy can use a common payment provider, such as, for example, Venmo™. It will be appreciated that the share of the purchase price by each member of the divvy can vary. For example, if there are five members (user 252, borrowers 280-286) of the divvy 620 who will be sharing the purchase price. An equal cost allocation will require each member to pay 20% of the purchase price; however, user 252 can pay a disproportionate amount of the purchase price (e.g. 30%, to gain majority ownership rights over item 654, or because user 252 can afford to pay more). It will be appreciated that a member of the divvy can also share any portion of the purchase price.

The purchaser member can then use the contributed funds, as well as his/her own funds to finalize the purchase. After the purchase is made, the purchaser member can add the item 654 to divvy 620, as disclosed in step 214 of FIG. 2. The purchaser member may be identified as the owner of the item 654, or ownership of the item 654 can be delegated to another member of the divvy. Item 654 can then be shared with the members of the divvy as disclosed previously.

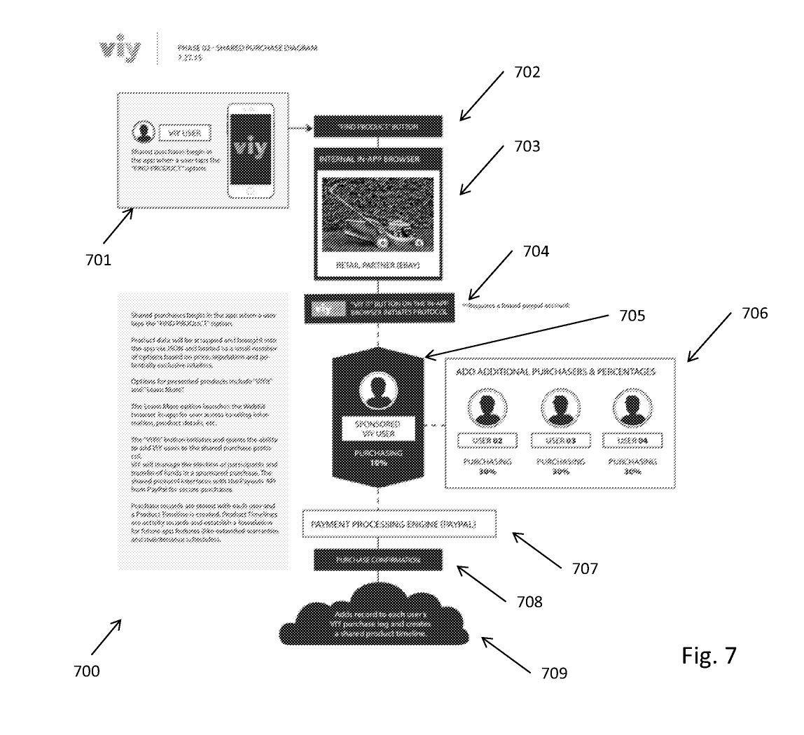

Referring now to FIG. 7, it is shown a drawing of an architecture and process flow 700 for group purchasing and sharing. As shown in FIG. 7, the architecture and process flow 700 include a user and user device 701, client software encompassed in components 702, 703, and 704 and a backend group purchasing and sharing system encompassed by components 705, 706, 707, 708, and 709. Of course, although each component herein is identified as being associated with client software or the Viy system, it should be appreciated that the client software is in communication with the Viy system such that each step may include information pulled from or transmitted to the Viy system from the client software and vice versa. The identification of each component as being associated with the client software or the Viy system is for exemplary purposes only.

It should be appreciated that the architecture and process flow 700 may be implemented in an architecture similar to that described in FIG. 1. It should further be appreciated that the group purchasing and sharing system may communicate with the client software through a computer network, such as, for example, the Internet through web services infrastructure. It should further be appreciated that the client software may be an application on a smartphone operated by the user or a web browser.

As shown in FIG. 7, the user and user device 701 may request to find products to group purchasing by interacting with (e.g. clicking) on a find product button 702 within the client software. An internal application browser to the client software 703 will communicate with the Viy backend system to identify retail partners where group purchasing might be available. As shown in FIG. 7 with a lawnmower, the items available for group purchasing might be durable goods. When the user identifies a product that he or she would like to obtain through group purchase, the user may interact with the in-client software browser by clicking a purchase button 704.

This interaction adds the interest of the user to group purchase the identified good (in the example shown in FIG. 7, a lawnmower) through the backend system. In this example shown in FIG. 7, the user 701 who initiated the purchase request becomes the sponsored user 705 and selects the amount that this user will contribute to the group purchase. To perform a group purchase, the user adds additional purchasers 706 to the group purchase request by interacting with the client software which identifies individuals in the Viy system. The list of purchasers may include previously identified friends of the user 701 in the Viy system, such as, for example, from divvies that the user 701 has entered into.

Additional group purchasers are selected until 100% of the cost of the purchase is allocated among the group purchasers. It should be appreciated that the sponsored user 705 may contribute less to the overall purchase (in this example, 10% vs. 30% contributed by added users) because the sponsored user 705 will be storing the product which has an implicit cost as discussed previously.

Once 100% of the purchase is allocated, the Viy system then processes the group purchase of the durable good through a payment engine 707 linked for each group purchaser and sends a confirmation 708 to each group purchaser. The Viy system also creates a divvy 709 for each group purchaser to start sharing the group purchased product when it arrives.

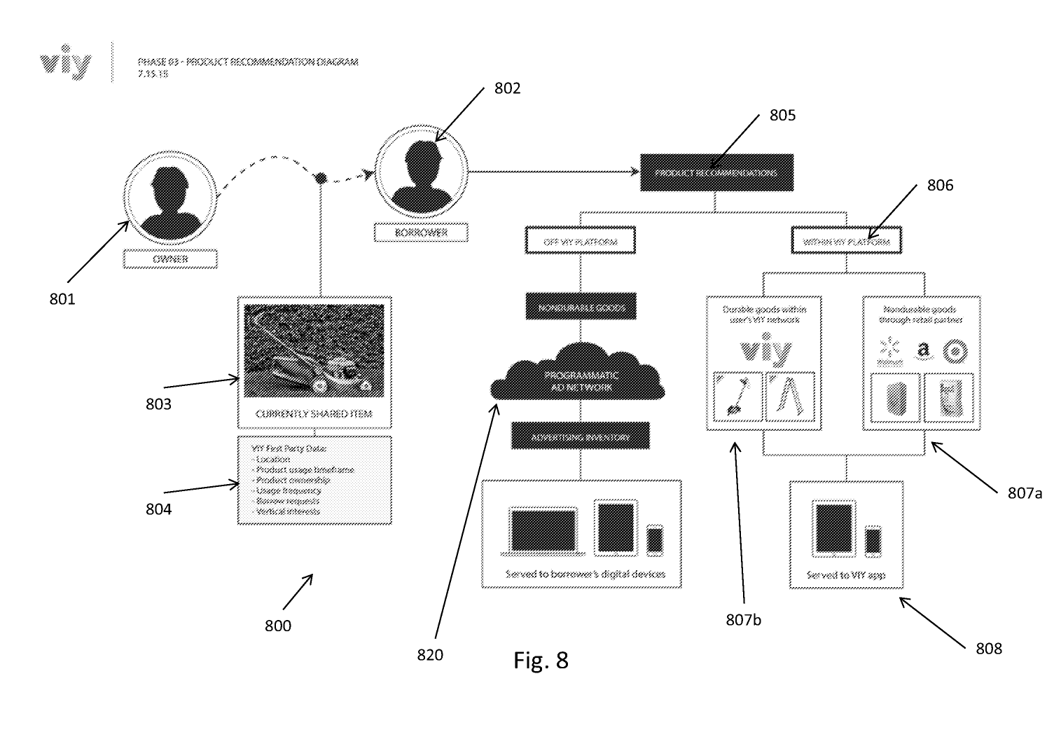

Referring now to FIG. 8, it is shown an architecture and process flow 800 for group purchasing and sharing. As shown in FIG. 8, data 804 is generated in the Viy system from an owner 801 of a durable good 803 being shared to a borrower 802. The data 804 may include the location of the item, how long the item is being used, the owner of the item, how often the item is being shared, how many requests for sharing the owner has received, interests of those requesting the item to be shared, and others.

For example, as shown in FIG. 8, a lawnmower is being shared. In this example, data 804 associated with sharing that lawnmower from the owner 801 to the borrower 802 may include that the borrower 802 first borrowed the lawnmower on Aug. 1, 2016 and plans to keep it borrowed until Aug. 10, 2016. In addition, the data 804 may also include that the borrowers (including borrower 802) of the lawnmower have a common interest of home gardening equipment.

The Viy system may use information gleaned from the owner 801 and borrower 802 relationship to generate product recommendations 805 for the purchase of non-durable goods and the sharing of durable goods. For example, when a borrower 802 is using a lawnmower, the borrower may need to purchase additional gardening tools in order to complete the task of mowing a lawn, like trash bags or compost bags. In this example, the Viy system 806 may make recommendations for the borrower 802 to purchase these non-durable goods from a Viy system partner 807a, such as, for example, an online retailer like Amazon, Wal-Mart, or Target. The Viy system may also recommended that the borrower 802 obtain additional durable goods from other users within the Viy system 807b. In this example, the Viy system may recommend that the borrower 802 obtain a ladder, trimmer, or other gardening tools to assist the borrower 802 with the gardening project where he or she is using the lawnmower. All of these recommendations are served to the borrower 802 through the client software 808 on the borrower's smart phone or web browser.

It should further be appreciated that the Viy system may utilize a programmatic advertiser network 820 to recommend non-durable goods for purchase. That is, the Viy system may sell ad space to present advertisements to the borrower 802 based on the borrower's 802 sharing habits. The data 804 generated from a sharing economy has, until the present application, never been captured by advertisers. Advertisers are limited to reacting to user purchases or viewing habits in online properties. With the Viy system and the present disclosure herein, an advertiser network may obtain a new type of user data: sharing and sharing interests.

As an example, in a traditional purchase economy, if a homeowner borrows his neighbor's lawnmower, an advertiser is given no insight into that private transaction. In the Viy system, when that same homeowner acts as a borrower 802 to the neighbor 801 that owns the lawnmower 803, the transaction is captured and data 804 is generated. This data 804 provides unique advertising opportunities for nondurable goods related to that transaction through an advertising network 820. The system 100 could be configured to provide specific ownership and borrowing information on specific users so that, for example, the owner of the lawnmower in the previous example would be shown fertilizer ads but not lawnmower ads, and the borrower of the lawnmower may be shown ads for lawnmowers.

It will therefore be appreciated that the present disclosures includes a system and methods to efficiently, reliably, and quickly allow consumers to purchase, share, and borrow items and services, thereby decreasing spending and associated storage costs.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A computerized method for group purchasing and sharing, the method comprising:
receiving, at a web services infrastructure, an item information pertaining to an item from a user device, the item information comprising at least one of a name and photograph;
automatically adding a user associated with the user device to the item information;
associating the user as owner of the item to the item information;
receiving, at the web services infrastructure, an indication from the user device to share the item with a plurality of trusted users;
automatically assigning a status of the item as available; and
sharing, through the web services infrastructure, to the plurality of trusted users, the item.

2. The method of claim 1, further comprising:
receiving, at the web services infrastructure, a request from a second user to borrow the item;
verifying the second user against the plurality of trusted users;
in the event that the second user is one of the plurality of trusted users:
automatically assigning the status of the item as shared; and
notifying the user and the second user that the second user is borrowing the item from the first user.

3. A computerized method for group purchasing and sharing, the method comprising:
creating a divvy, the divvy comprising a plurality of items available for sharing and a plurality of trusted users available to borrow each of the plurality of items, wherein each item in the plurality of items is associated with an item information comprising a name, owner, and status in a database;
displaying the divvy to each user in the plurality of users through client software at a client device;
receiving, through a web services infrastructure transmission associated with the divvy, a request from at least one user in the plurality of users to borrow at least one item in the plurality of items;
verifying, with the database, that the status of the requested item is available; and
in the event that the status of the requested item is available, notifying the requesting user and the owner that the requesting user is borrowing the item from the owner.

4. The method of claim 3, wherein each owner is a user in the plurality of users.

5. The method of claim 3, further comprising:
receiving, through the web services infrastructure, a request from one user in the plurality of users to add at least one new user to the divvy; and
transmitting a notification to the new user an invitation to the divvy.

6. The method of claim 3, wherein in the event that the verifying step indicates that the status of the requested item is unavailable, notifying the requesting user that the requested item is unavailable to borrow.

7. The method of claim 3, further comprising:
identifying, by a lead user in the plurality of users, an item desirable to the plurality of users in the divvy that is available for purchase, the item having a cost;
allocating, by the lead user, the cost of the desirable item among the plurality of users;
purchasing the desirable item at the cost based on the allocating step;
assigning the lead user as the owner of the item in the database; and
adding the item to the divvy.

8. The method of claim 7, wherein the cost comprises a monetary cost and a storage space requirement.

9. The method of claim 3, wherein the client software is a smartphone application.

10. The method of claim 3, wherein each item in the plurality of items is a durable good.

11. A system for group purchasing and sharing, the system comprising:
a database;
a server connected to the database and hosting a web services infrastructure, the web services infrastructure being configured to receive requests from a client device to:
create a divvy, the divvy comprising a plurality of items available for sharing and a plurality of trusted users available to borrow each of the plurality of items, wherein each item in the plurality of items is associated with an item information comprising a name, owner, and status in a database, receive a request from a user in the plurality of users to borrow at least one item in the plurality of items, verify, in the database, that the status of the requested item is available, and notify the requesting user and the owner that the requesting user is borrowing the item from the owner.

12. The system of claim 11, further comprising:
a client device with software configured to retrieve the divvy from the web services infrastructure and display the divvy to the user, and receive the notification.

13. The system of claim 12, wherein the server is further configured to, in the event that the status of the requested item is unavailable, notify the requesting user that the requested item is unavailable to borrow.

14. The system of claim 11, wherein each owner is a user in the plurality of users.

15. The system of claim 11, wherein the server is further configured to receive a request from one user in the plurality of users to add at least one new user to the divvy, and transmit a notification to the new user an invitation to the divvy.

16. The system of claim 11, wherein the server is further configured to:
identify, by a lead user in the plurality of users, an item desirable to the plurality of users in the divvy that is available for purchase, the item having a cost, allocate, based on an input from the lead user, the cost of the desirable item among the plurality of users, purchase the desirable item at the cost based on the allocating step, assign the lead user as the owner of the item in the database, and add the item to the divvy.

17. The system of claim 16, wherein the cost comprises a monetary cost and a storage space requirement.

18. The system of claim 11, wherein the client software is a smartphone application.

19. The system of claim 11, wherein each item in the plurality of items is a durable good.
